(19) United States
(12) Patent Application Publication
(10) Pub. No.: US 2005/0166258 A1
(43) Pub. Date: Jul. 28, 2005

(54) Centralized digital video recording system with bookmarking and playback from multiple locations

(76) Inventors: Alexander Vasilevsky, Westford, MA (US); Carlton J. Sparrell, Marblehead, MA (US); David F. Lively, Hudson, MA (US); Nick Schmidt, Brookline, MA (US)

Correspondence Address: COVINGTON & BURLING;ATTN: PATENT DOCKETING, 1201 PENNSYLVANIA AVENUE, N.W., WASHINGTON, DC, 20004-2401, US

(21) Appl. No.: 10/503,808

(22) PCT Filed: Apr. 11, 2002
(86) PCT No.: PCT/US02/11402

Related U.S. Application Data
(60) Provisional application No. 60/355,105, filed on Feb. 8, 2002.

(51) Int. Cl. H04N 7/173; H04N 7/16

(52) U.S. Cl. 725/138; 725/135; 725/88

(57) ABSTRACT

A centralized Digital Video Recording (DVR) and reproduction system (100) linking several reproduction and control units (such as television receivers (124, 128, 132), etc.) to a centralized media server (152) allows system users (124, 128, 132) to not only access the same program or programs from different receivers (106, 110), but to pause and resume the same programs from the same marker points (“bookmarks”) established by any system user (124, 128, 132). The program “bookmark” representing the program pause point is conveniently shown via a graphical user interface display with a bookmark icon, including the name of the user (124, 128, 132) who established the bookmark and the exact pause point in the program.

### INCORPORATION BY REFERENCE

The present application claims the priority of U.S. Provisional Application for Patent Ser. No. 60/355,105 filed Feb. 8, 2002, and incorporates the contents of that application herein by reference. The present application also claims the benefit of and incorporates herein by reference the contents of the following commonly owned applications:
U.S. patent application Ser. No. 09/365,726 filed Aug. 3, 1999, entitled “Multi-Service In-Home Network With an Open Interface”;
U.S. patent application Ser. No. 09/809,770 (Att. Dkt. UCN-006) filed Mar. 16, 2001, entitled “Home Area Network Including Arrangement for Distributing Television Programming Over Local Cable”;
U.S. Patent Application Ser. No. 60/193,813, filed Mar. 31, 2000, entitled “Home Area Network”;
U.S. Patent Application Ser. No. 60/313,209 (Atty. Dkt. UCN-011), filed Aug. 17, 2001, entitled “Delivering Multimedia Over Home Area Networks”;
U.S. Patent Application Ser. No. 60/313,228, filed Aug. 17, 2001, entitled “Web Services Provisioning Architecture”;
U.S. Provisional Application for Patent Ser. No. 60/327,627 (Atty. Dkt. UCN-012), filed Oct. 5, 2001, entitled “Home Area Network Centralized Video Recorder”;
U.S. Patent Application Ser. No. 60/345,966 (Atty. Dkt. UCN-017), filed Nov. 7, 2001, entitled “Digital Video Recording System Supporting Concurrent Playback Using Advanced Program Information”;
U.S. patent application Ser. No. 10/017,675 (Atty. Dkt. UCN-018) filed Dec. 15, 2001, entitled “Centralized Digital Video Recording and Playback System Accessible To Multiple Reproduction And Control Units Via A Home Area Network”; and
U.S. patent application Ser. No. 10/032,218 (Atty. Dkt. UCN-015) filed Dec. 21, 2001, entitled “Digital Video Recording and Reproduction System And Method Suitable For Live-Pause Playback Utilizing Intelligent Buffer Memory Allocation”.

### BACKGROUND OF THE INVENTION

1. Field of the Invention

The present invention broadly relates to digital recording and playback systems and methods administered by home area networks. More particularly, the present invention relates to improving cooperative functionality and convenience of viewing among all of the individual receivers in the home area network without the substantial costs associated without adding substantial hardware and cost to each receiver.

2. Background

Digital Video Recording and Playback systems are becoming more commonplace, with advances in technology and the downward trend in prices. Along with a playback quality that is superior to analog-based systems, Digital Video Recorders (DVRs) also allow other features that are not practical with analog-based systems. Among such features is the ability of a DVR user to engage in “live-pause” or “elastic” recording and playback.

Live-pause recording and playback allows a viewer/user with such an enabled system to watch a program live while the program is being simultaneously recorded, and also allows the user to use “trick play” modes or functions such as pausing the program or rewinding the program. While the recorded program is being paused or rewound, the system continues to record the program in a buffer memory. The system keeps track of where in memory the user has exited to perform trick play functions. The user can later return to the previous point of viewing in the program or skip with a “fast forward” operation up to the most current point of recording. Live-pause recording and playback allows the user the flexibility of watching a program live, already recorded, or a combination of both live and recorded viewing, along with other interesting trick play modes.

Home Area Networks (HANs) are typically small-scale electronic cable or wire based communication networks used to interconnect a variety of small to moderate sized appliances, computers, and consumer electronic devices. Their cost and attributes make them especially suitable for typical homes or smaller buildings. Communication between devices may be via one or more of several well-known protocols or information formats. HANs can be general in their functionality, such as controlling the operation of several in-home devices such as appliances, television receivers, telephonic devices and burglar alarm systems, or they may be more specialized in their functionality, such as only controlling the operation of several television receivers and connecting the receivers to an extra-home television program source such as a cable or satellite television service provider.

A well-designed and well-implemented HAN can allow resource sharing between one or more workhorse devices and the several attached devices, giving the attached devices greater capability and functionality than they would otherwise possess.

Of special interest to the inventors of the subject matter of these Letters Patent are home area-networked video recording and playback systems having multiple television receivers or reproduction devices. It is desirable to be able to allow the playback of the same program from different receivers. Also desirable is the ability to allow live-pause playback and delayed viewing playback from more than one receiver. Further, it is desirable to allow a user to pause the playback of a program (whether in a live-pause or conventional playback mode) from one receiver, and to resume playback of the program from the pause point via one of the other receivers.

The prior art approach to facilitating the aforementioned “seamless” pause and playback feature (of the same program) using multiple receivers is to equip each receiver with the necessary hardware and software to accomplish playback. In other words, each receiver must have embedded or attached, a high-capacity storage device for storing the information representing the program, a video decoder, perhaps a video encoder, one or more tuners, and perhaps a digital audio decoder, to name a few. The aforementioned items are normally included in a set-top box. The inclusion of a deluxe set-top box for each receiver greatly increases the cost and complexity of the system. Moreover, prior art redundant systems do not allow playback of the same program from the previously established “bookmark” (pause point) if the “bookmark” was not established using the receiver currently carrying out playback.

It is therefore desirable to significantly improve the prior art by providing a system with a seamless pause and playback feature where either pause or resumption of playback from an established “bookmark” can occur from any of the receivers, and without the increased cost of related prior art approaches.

### SUMMARY OF THE INVENTION

In view of the aforementioned problems and deficiencies of the prior art, the present invention provides a distributed audio-visual reproduction system that at least includes a network adapted to facilitate the transmission and reception of information between components coupled thereto, a plurality of program reproduction devices coupled to the network, the reproduction devices being adapted to reproduce programs in a user-perceivable manner, and a media server coupled to the network, the media server being adapted to receive and store programs reproducible by the reproduction devices, and the media server being adapted to upon the demand of a user via a reproduction device, transmit in a reproducible format, programs to the reproduction devices. The media server is further adapted to allow a user to, from one reproduction device, place a program bookmark in a program representing a point in the program where reproduction has stopped, and from another reproduction device, resume reproduction of the program from the program bookmark.

The present invention also provides a distributed audio-visual reproduction method that at least includes the steps of, via a network, facilitating the transmission and reception of information between components coupled to the network, via a plurality of program reproduction devices coupled to the network, reproducing programs in a user-perceivable manner, via a media server coupled to the network, receiving and storing programs reproducible by the reproduction devices, via the media server, and upon the demand of a user via a reproduction device, transmitting in a reproducible format, programs to the reproduction devices, via one reproduction device and the media server, and upon the demand of a user, placing a program bookmark in a stored program representing a point in the program where reproduction has stopped, and via another reproduction device and the media server, and upon the demand of a user, resuming reproduction of the program from the program bookmark.

### BRIEF DESCRIPTION OF THE DRAWING FIGURES

Features and advantages of the present invention will become apparent to those skilled in the art from the description below, with reference to the following drawing figures, in which:

FIG. 1 is a schematic block diagram of the present home area-networked digital video recording and playback system allowing video bookmarking and playback of the same program from different receivers/reproduction devices;

FIG. 2 is an example of a general Graphical User Interface display provided to system users, showing the recorded programs available for viewing by said users;

FIG. 3 is an example of a general Graphical User Interface display linked to the Graphical User Interface display in FIG. 2, giving greater details about a program highlighted in the display of FIG. 2;

FIG. 4 is an example of a general Graphical User Interface display, giving details about program “bookmarks” currently active in a highlighted program;

FIG. 5 is an alternative to FIG. 4, primarily representing program “bookmarks” by still pictures of video programs corresponding to the bookmarks in a highlighted program;

FIG. 6 is an alternative to FIG. 4, with a modified bookmark identification box enabling a user to enter a description of the bookmark and the scene represented by the bookmark; and

FIG. 7 is yet another alternative to FIG. 4, with the bookmark in the form of a detailed text box.

### DESCRIPTION OF THE PREFERRED EMBODIMENTS

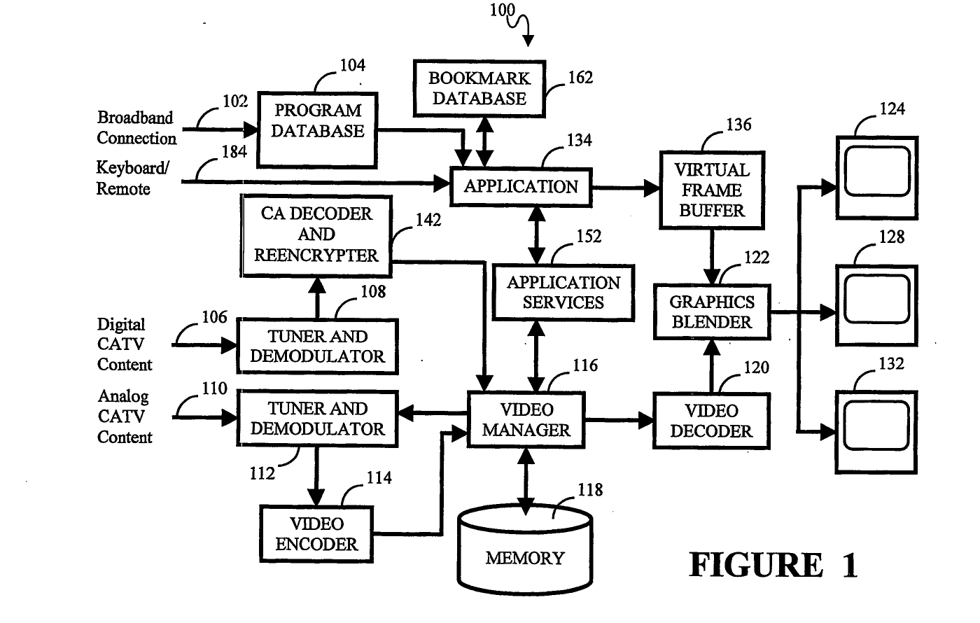

The present home area-networked digital video recording and playback system 100, capable of program bookmarking and playback resumption of the same program from multiple receivers, is explained below with reference to FIG. 1. In its elementary form, the system 100 combines a media server for receiving and storing multiple electronic audio-visual programs (e.g., digital or analog television broadcasts, video recordings such as those provided by video-on-demand services, or even audio programs), and several reproduction devices such as digital or analog television sets (124, 128 and 132) via a home area network (HAN). The media server acts as a centralized Digital Video Recorder and Playback device for all of the receivers connected to the HAN.

In the preferred embodiment, the media server contains all of the components of the system 100 shown in FIG. 1, except the receivers 124, 128 and 132, graphics blender 122, video decoder 120, and the connections 102, 106, 110 and 184. A graphics blender 122 and video decoder 120 can be included in a set-top box for each receiver 124, 128 and 132.

The home area network (HAN) subsumes all of the major connections between the components in the system 100, and is essentially a computer bus adapted for both digital communication and the transport of digital video and digital audio multimedia content compatible with digital television receivers. Those skilled in the art will appreciate that there are a number of bus standards that can be employed without departing from the scope of the present invention.

Newer-design television sets can connect directly to the HAN via video bus cable jacks, or via wireless transceivers connected to the video bus jacks. Television sets with older designs can connect to the HAN via converters, ideally in the form of set-top boxes. In the preferred embodiment, the set-top boxes subsume the units 120 and 122. The video decoder 120 of each set-top box is responsible for decoding and decrypting digital program signals from the media server, as well as rendering the decoded and decrypted signals compatible for display with the television receivers 124, 128 and 132.

A program database 104 obtains information used by the system 100 to construct an electronic program guide (EPG) to present details about programs to the system and to viewers in the form of a graphical user interface. In the preferred embodiment, the program database 104 obtains programming information via a broadband or wide area network (WAN) connection 102 to a host computer (not shown). Those skilled in the art will appreciate that the programming information can be obtained through other types of connections, such as, inter alia, a cable MODEM, xDSL, POTS MODEM, satellite, and fixed terrestrial wireless.

For programs to be viewed and reproduced by the system 100, the program database provides information such as the program name, start and end times, channel designation, and additional information about the program such as the program rating, and a program synopsis. In an alternative system, the program guide information can be delivered in a different manner, such as in the video program stream as is known in the art. That is, along with the other audio and video information representing a television channel, for example, headers and other program description information can be included (e.g., program description information can be inserted in the vertical blanking interval of an NTSC television signal).

Via inputs 106 and 110, the system 100 also receives digital and analog television program signals to be processed by tuner and demodulator circuits 108 and 112, respectively. The tuner and demodulator circuits have the function of tuning into program channels selected to be received by the system 100 and then demodulating them in a manner known in the art.

The analog content signal need not initially be in a modulated form, as in the example, but may be unmodulated, in which case the tuning and demodulation circuit 112 is bypassed. Such an unmodulated analog content signal may be coupled to the system 100 via an “S-video” jack. Similarly, the digital content signal can be received either in a modulated form, or an unmodulated form (such as a straight ATSC stream), which for the latter case, the tuning and demodulation circuit 108 is bypassed.

The television signals and other program signals are stored in memory 118 in a predefined manner or as dictated by a user using a keyboard or remote control device via input 184. The input signals are in response to a graphical user interface displayed on the receiver screens. In the preferred embodiment, the memory 118 is a high-capacity hard disk drive, although other forms of memory systems are compatible. The writing of program content information to memory and the reading of program content information from memory are controlled by a video manager 116.

Prior to storage in memory, the analog program signals from the tuning and demodulating circuit 112 are digitized and then encoded via a video encoder 114, using a digital compression scheme such as those established by the Motion Picture Experts Group (MPEG). These include the MPEG-2, MPEG-4 and other standards. In the preferred embodiment, the program signals are stored as Elementary Streams, as will be familiar to those skilled in the art. Where appropriate, the digital program signals are decoded and re-encrypted by the circuit 142 prior to storage as an Elementary Stream in the memory 118. The exact point of decryption in the system is a matter of design choice dictated by such factors as the legal requirements and restrictions of the content providers who broadcast the program signals. These requirements and restrictions relate to preventing unauthorized access and copying of programs. Where allowable, the circuit 142 can decrypt and then re-encrypt program streams using symmetric encryption algorithms, as will be understood by those skilled in the art, so that the receivers 124, 128 and 132 need not contain substantial hardware and/or software complexities.

The communication and transport of program information between the media server and the various user control and reproduction devices (or client devices, or receivers) can be via a number of network and streaming protocols, including, inter alia: Real-Time Transport Protocol (RTP); Real-Time Streaming Protocol (RTSP); Transmission Control Protocol Protocol (TCP); User Datagram Protocol (UDP); Network File System (NFS) Protocol; Web-Distributed Authoring and Versioning (WebDAV) Protocol; Server Message Block (SMB) Protocol; IEEE 1394 Protocol; and Internet Small Computer System Interface (iSCSI) Protocol.

The system users communicate with the media server via a user interface or Application Unit 134, which converts user commands to commands compatible with the media server. The Application Unit 134 is also responsible for generating a graphical user interface (GUI) containing an electronic program guide (EPG) for display, and input by an Application Services Unit 152. The Application Services Unit 152 controls the recording and playback of programs. Under the direction of the Application Unit 134 and utilizing program guide information, the Application Services Unit 152 establishes the necessary memory needed for recording a particular program, whether the recording is of the traditional or live-pause variety.

Those skilled in the art will appreciate that the media server can be structured differently from that illustrated, and can include more or fewer of the components in FIG. 1. The most important aspect of the media server is that it is a centrally located means for storing multiple programs that are readily and contemporaneously accessible by, and readily and contemporaneously controlled by multiple local client devices via a HAN.

The HAN can be administered using many suitable access and conflict resolution schemes for managing the flow of information between the media server and the several receivers 124, 128, and 132, without departing from the scope of the present invention. For example, older Ethernet approaches using token rings will suffice. However, it will be appreciated by those skilled in the art that later Ethernet approaches such as the 10/100BaseT UTP (Universal Twisted Pair) utilizing Carrier Sense Multiple Access (CSMA) with Collision Detect (CSMA/CD) will also suffice. Using the latter approach, a station/receiver desiring to transmit information seeks a free carrier line. When a free line is obtained, the station/receiver begins transmitting while simultaneously checking for collisions with other stations/receivers attempting to use the same carrier line. If a collision is detected, transmission halts and the station/receiver releases the carrier line for a random or pseudo-random amount of time until the carrier line appears to be free, after which, retransmission is attempted.

Still other approaches such as Carrier Sense Multiple Access with Collision Avoidance (CSMA/CA) can be used. Examples of networks using the CSMA/CA scheme include the 802.11a and 802.11b Wireless Networks. Instead of attempting to detect collisions, the networked wireless devices look for an available transmission band, and then transmit after a random or pseudo-random amount of time. If an acknowledgment signal (ACK) is received within an expected window, the devices assume that no collision has occurred. If an ACK signal has not been timely received, the devices assume there has been a conflict with another device, and then attempt to retransmit the information.

Yet other approaches (e.g., Hiperian/2 and bluetooth wireless, and IEEE 1394 wired) include those employing a Time Division Multiple Access (TDMA) scheme. The stations/receivers can transmit during fixed designated time slots, or in the case of schemes such as IEEE 1394, during a guaranteed, but variably located time slot.

A graphics blender 122 performs the function of blending disparate video streams into one signal compatible with the displays 124, 128 and 132. Typically, this involves combining an interactive graphical user interface (GUI) having the program guide information with the program being viewed.

A virtual frame buffer 136 holds the GUI information for refreshing the displays 124, 128 and 132. In the preferred embodiment, video decoding and graphic blending are local to the receivers. However, it is possible to integrate these functions into a more complex media server.

In operation, a viewer can retrieve programming from the server from any of the networked receivers. The same program can be watched simultaneously by more than one receiver if desired. Further, live-pause control and playback can be executed from any networked receiver, allowing a program to be viewed in the live-pause mode in a seamless manner from more than one receiver. For example, a program being viewed on one receiver can be paused. Later, the same program can be resumed from the same pause point and viewed, but from a different receiver.

Therefore, both the viewing and control of programming can be distributed among multiple receivers in a seamless manner if desired. It should be appreciated by those skilled in the art that all trick play modes can be distributed across multiple receivers for a single program as described above with respect to the “pause” mode. For example, a viewer who has previously paused or rewound a program being recorded in live-pause mode can decide to “fast forward” to another point using one receiver, and then resume viewing from the stopping point (of the fast forward operation) using another receiver.

When a system user pauses the playback of a particular program, he or she can decide whether to “bookmark” the program. That is, an electronic marker can be placed in memory indicating exactly where the program was paused, along with other particulars such as the identity of the user, and the date and time of the bookmark. When a command is received to enter a bookmark, the Application Unit 134 causes the bookmark to be stored in a bookmark database 162, along with program identity information so that the bookmark can be matched to the appropriate program stored in memory 118.

In the preferred embodiment, any user with access to the system can place or establish program bookmarks in a program being reproduced. Any user can also access the bookmarks of other users and resume the playback of any available program from any bookmark, regardless of who established it. Furthermore, bookmarking and resumption of playback can be carried out from any system receiver. In an alternate embodiment, only a user who established a particular bookmark can use that particular bookmark for resumption of playback. Using this latter approach, it may be desirable to display to particular users, only those bookmarks that they have in fact established.

While the components 120, 122, 134, 136 and 152 are part of the centralized media server in the preferred embodiment, it should be understood that these components might be implemented in a client system or other end-user equipment (e.g., 124, 128 and 132), in an alternate embodiment. While today's processor and memory prices dictate that the aforementioned components are better incorporated in the centralized media server to serve “thin” clients, future price reductions (and/or performance increases) in these elements may make the inclusion of these components in client or end-user equipment economically feasible.

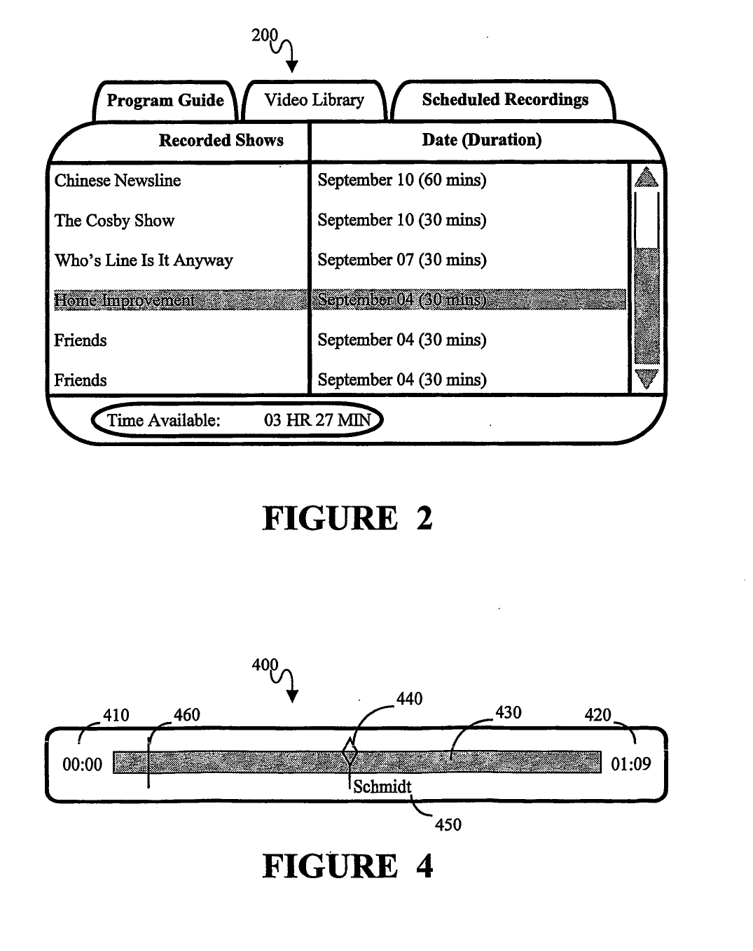

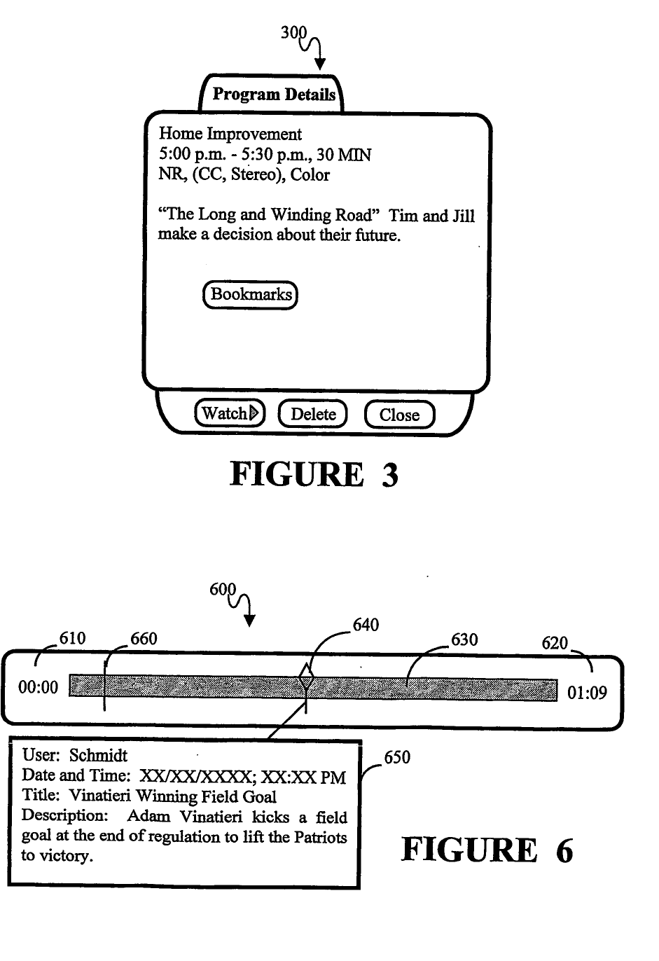

FIG. 2 illustrates an example of a program guide display 200 presented to a system user, which display contains previously stored programs on the media server, or those in the process of being viewed in the live-pause mode. By highlighting a particular program, more detailed information can be obtained from the “Program Details” display 300 in FIG. 3. The “Program Details” display 300 allows a user to reproduce the particular program from the start, or from a previously established bookmark.

Activating a “bookmarks” button in the display 200 causes the GUI to produce a toolbar or the like, which shows the bookmarks that have been established for the program. The bookmark display 400 contains a start time display area 410 and end time display area 420, indicating the program length. A program length bar 430 is shown in the middle of the display. In the example shown, a bookmark icon 440 represents a program bookmark that has been established by User Schmidt (identifier 450). Position 460 can represent a previous bookmark of a user that has been updated to a new position. The bookmark display 400 can contain all of the active bookmarks for the program, or only those to which the user has access.

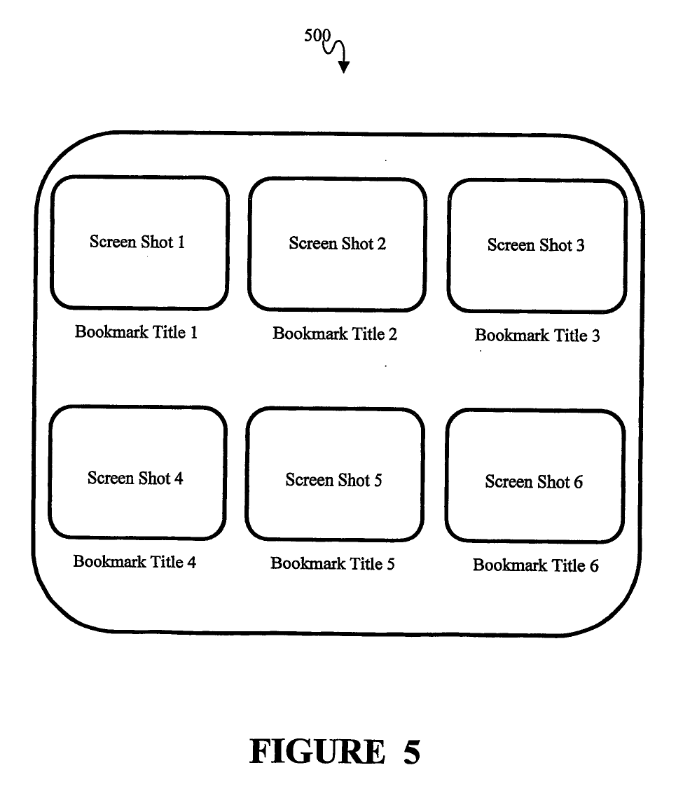

The iconic manner of displaying program bookmarks is by no means limited to the display 400. For example, program bookmarks can be displayed in the form of still photographs corresponding to the video scenes at the time a program is paused. An example of this type of display 500 is shown in FIG. 5. Other forms of bookmark icons and bookmark displays are possible given the teachings of the present invention.

FIG. 6 shows a variation 600 of the bookmark display 400 in FIG. 4. The elements 610, 620, 630, 640, 650 and 660 are analogous to the elements 410, 420, 430, 440, 450 and 460, respectively. However, the identifier 650 is in the form of a more detailed text box that includes such information as the bookmark establisher's name, a title of the bookmark, and a brief description of what occurred in the program just prior to the pause point. A system user can enter or modify all of the information.

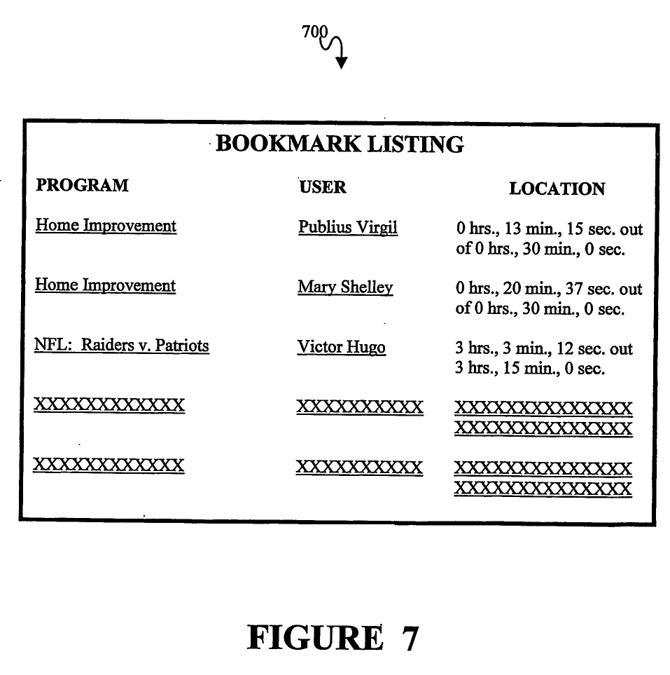

Another variation of showing bookmarks isn't iconic at all, but rather completely textual, as shown in the display 700 of FIG. 7. In that figure it can be seen that all of the bookmarks accessible to system users are listed by program, user and program pause location. Using this approach, it is also possible to gain more information about the bookmark by clicking a pointing device on the desired bookmark in the “program” column. Alternatively, or in conjunction, clicking on the bookmark can lead directly to the pause point in the program of the representative bookmark. A user can see other bookmarks established by other system users by clicking on the other users' names in the “user” column. In the example shown, two different system users (Publius Virgil and Mary Shelley) have placed bookmarks in the same program (“Home Improvement”).

Variations and modifications of the present invention are possible, given the above description. However, all variations and modifications which are obvious to those skilled in the art to which the present invention pertains are considered to be within the scope of the protection granted by this Letters Patent.

For example, the description of program bookmarks has been directed to allowing the user to decide when to bookmark a program. It is also possible for the system to automatically establish a single program bookmark when a program being reproduced is paused. Using this approach, the system might also automatically overwrite an existing bookmark with a new bookmark when the reproduction pauses at the same point as that represented by the old bookmark.

It is also possible to construct the system so that when reproduction of a program begins, the program is automatically skipped to the single bookmark. Alternatively, rather than automatically skipping to the bookmark, the user can choose to skip to the bookmark by activating a “resume” function from a remote control device or pointing device. Further, the system can be modified to automatically establish a program bookmark when the user initiates a “pause” function, but not automatically establish a program bookmark when the user initiates a “stop” function.

1. A distributed audio-visual reproduction system comprising:
a network adapted to facilitate the transmission and reception of information between components coupled thereto;
a plurality of program reproduction devices coupled to said network, said reproduction devices being adapted to reproduce programs in a user-perceivable manner; and
a media server coupled to said network, said media server being adapted to receive and store programs reproducible by said reproduction devices, and said media server being adapted to upon the demand of a user via a reproduction device, transmit in a reproducible format, programs to said reproduction devices;
wherein said media server is further adapted to allow a user to, from one reproduction device, place a program bookmark in a program representing a point in the program where reproduction has stopped, and from another reproduction device, resume reproduction of the program from the program bookmark.

2. The system of claim 1, wherein said media server is adapted to receive and maintain a plurality of active program bookmarks in the same program from different users.

3. The system of claim 1, wherein said system is adapted to function in a “live-pause” mode.

4. The system of claim 1, wherein said media server is adapted to enable any program bookmark to be edited by any authorized system user.

5. The system of claim 1, wherein said media server is adapted to enable a particular program bookmark to be edited only by a user purporting to have established the particular bookmark.

6. The system of claim 1, wherein said media server is adapted to enable access to a particular bookmark and program resumption from that bookmark only if the user requesting playback of the program purports to have established the particular bookmark, and said media server is further adapted to enable general reproduction of a program from a reproduction device regardless of whether the user controlling the reproduction device purports to have established the particular bookmark.

7. The system of claim 1, wherein said media server further comprises:
a graphical user interface generator adapted to generate a display having program bookmark indicia representing program bookmarks pertaining to programs being viewed, wherein said bookmark indicia comprise user identity information pertaining to the user establishing the program bookmark.

8. The system of claim 1, wherein said media server further comprises:
a graphical user interface generator adapted to generate a display of still pictures associated with currently active program bookmarks pertaining to a program being viewed.

9. The system of claim 1, wherein said reproduction devices subsume television receivers, and said programs are television-compatible.

10. The system of claim 1, wherein said programs are audio programs.

11. The system of claim 7, wherein said bookmark indicia are modifiable by a user, and said bookmark indicia further comprise bookmark name information.

12. The system of claim 11, wherein said bookmark indicia further comprise program description information corresponding to the pause point in a program.

13. The system of claim 1, wherein said program bookmark is adapted to be displayed to a user in the form of a textual representation.

14. The system of claim 13, wherein said textual representation comprises a program listing and program location of the bookmark.

15. A distributed audio-visual reproduction method comprising the steps of:
via a network, facilitating the transmission and reception of information between components coupled to said network;
via a plurality of program reproduction devices coupled to said network, reproducing programs in a user-perceivable manner;
via a media server coupled to said network, receiving and storing programs reproducible by said reproduction devices;
via said media server, and upon the demand of a user via a reproduction device, transmitting in a reproducible format, programs to said reproduction devices;
via one reproduction device and said media server, and upon the demand of a user, placing a program bookmark in a stored program representing a point in the program where reproduction has stopped; and
via another reproduction device and said media server, and upon the demand of a user, resuming reproduction of the program from the program bookmark.

16. The method of claim 15, further comprising the step of:
via said media server, receiving and maintaining a plurality of active program bookmarks in the same program from different users.

17. The method of claim 15, wherein the steps of said method are carried out during “live-pause” viewing of a program.

18. The method of claim 15, further comprising the step of:
via said media server, enabling any program bookmark to be edited by any authorized system user.

19. The method of claim 15, further comprising the step of:
via said media server, enabling a particular program bookmark to be edited only by a user purporting to have established the particular bookmark.

20. The method of claim 15, further comprising the steps of:
via said media server, enabling access to a particular bookmark and program resumption from that bookmark only if the user requesting playback of the program purports to have established the particular bookmark; and
via said media server, enabling general reproduction of a program from a reproduction device regardless of whether the user controlling the reproduction device purports to have established the particular bookmark.

21. The method of claim 15, further comprising the step of:
generating a graphical user interface display having program bookmark indicia representing program bookmarks pertaining to programs being viewed, wherein said bookmark indicia comprise user identity information pertaining to the user establishing the program bookmark.

22. The method of claim 15, further comprising the step of:
generating a graphical user interface display having still pictures associated with currently active program bookmarks pertaining to a program being viewed.

23. The method of claim 15, wherein said reproduction devices subsume television receivers, and said programs are television-compatible.

24. The method of claim 15, wherein said programs are audio programs.

25. The system of claim 21, wherein said bookmark indicia are modifiable by a user, and said bookmark indicia further comprise bookmark name information.

26. The system of claim 25, wherein said bookmark indicia further comprise program description information corresponding to the pause point in a program.

27. The system of claim 15, wherein said program bookmark is adapted to be displayed to a user in the form of a textual representation.

28. The system of claim 15, wherein said textual representation comprises a programs listing ard program location of the bookmark.

29. A distributed audio-visual reproduction system comprising:
a network adapted to facilitate the transmission and reception of information between components coupled thereto;
a plurality of program reproduction devices coupled to said network, said reproduction devices being adapted to reproduce programs in a user-perceivable manner; and
a media server coupled to said network, said media server being adapted to receive and store programs reproducible by said reproduction devices, and said media server being adapted to upon the demand of a user via a reproduction device, transmit in a reproducible format, programs to said reproduction devices;
wherein said media server is further adapted to automatically place a program bookmark in a program representing a point in the program where reproduction has paused on one reproduction device, and from another reproduction device, allow a user resume reproduction of the program from the program bookmark.

30. The system of claim 29, wherein said media server is further adapted to automatically overwrite an existing program bookmark where a current reproduction is paused at the same point represented by the existing program bookmark.

31. The system of claim 29, wherein said media server is further adapted to automatically begin a requested reproduction of a program from said program bookmark point.

32. The system of claim 29, wherein said media server is further adapted to, upon a reproduction user activating a “resume” function, begin a requested reproduction of a program from said program bookmark point.

33. The system of claim 29, wherein said media server is further adapted to disable said automatically placing a program bookmark in a program representing a point in the program where reproduction has paused on one reproduction device, when a reproduction user activates a “stop” function, rather than a “pause” function.

34. A distributed audio-visual reproduction method comprising the steps of:
via a network, facilitating the transmission and reception of information between components coupled to said network;
via a plurality of program reproduction devices coupled to said network, reproducing programs in a user-perceivable manner;
via a media server coupled to said network, receiving and storing programs reproducible by said reproduction devices;
via said media server, and upon the demand of a user via a reproduction device, transmitting in a reproducible format, programs to said reproduction devices;
via one reproduction device and said media server, automatically placing a program bookmark in a stored program representing a point in the program where reproduction has paused; and
via another reproduction device and said media server, and upon the demand of a user, resuming reproduction of the program from the program bookmark.

35. The method of claim 34, further comprising the step of:
automatically overwriting an existing program bookmark where a current reproduction is paused at the same point represented by the existing program bookmark.

36. The method of claim 34, further comprising the step of:
automatically beginning a requested reproduction of a program from said program bookmark point.

37. The method of claim 34, further comprising the step of:
upon a reproduction user activating a “resume” function, beginning a requested reproduction of a program from said program bookmark point.

38. The method of claim 34, further comprising the step of:
disabling said step of automatically placing a program bookmark in a program representing a point in the program where reproduction has paused on one reproduction device, when a reproduction user activates a “stop” function, rather than a “pause” function.
